(19) United States
(12) Patent Application Publication
(10) Pub. No.: US 2004/0261816 A1
(43) Pub. Date: Dec. 30, 2004

(54) Using bidentate chelators to clean semiconductor wafers

(76) Inventors: Justin K. Brask, Portland, OR (US); Vijayakumar S. Ramachandrarao, Hillsboro, OR (US)

Correspondence Address: Timothy N. Trop, TROP, PRUNER & HU, P.C., STE 100, 8554 KATY FWY, HOUSTON, TX, 77024-1841, US

(21) Appl. No.: 10/608,669

(22) Filed: Jun. 27, 2003

(51) Int. Cl. B08B 7/02

(52) U.S. Cl. 134/2; 134/26; 134/34

(57) ABSTRACT

Bidentate chelating ligands may be utilized to remove metal contaminants in semiconductor wafers. Each metal center may have three chelating ligands attached to it. The resulting complex may be removed as a vapor using a dynamic vacuum or a supercritical carbon dioxide, as two examples.

### BACKGROUND

This invention relates generally to cleaning semiconductor wafers prior to the formation of a gate electrode.

Metals may contaminate semiconductor wafers. Particularly, prior to the formation of the gate electrode, metal contaminants may be present on semiconductor wafers. It is important to remove those contaminants prior to the formation of the gate electrode.

One known technique for removing metal contaminants is to use a hexadentate chelating ligand. Dentate refers to the number of coordination sites or sites of attachment between the metal and the chelating ligand. A ligand is a molecule that is bonded directly and covalently to the metal center. A chelating ligand or chelate forms a ring that includes the metal center. Thus, with a hexadentate chelating ligand, six points of attachment are achieved between the chelating ligand and the metal center.

The six coordinate or hexadentate chelating ligand must be used in an aqueous liquid mixture. This leads to contamination from the aqueous liquid and also limits the type of molecular surface termination or conditioning that is achievable.

Thus, there is a need for better ways to clean semiconductor wafers.

### DETAILED DESCRIPTION

Volatile, bidentate chemical complexing agents may be used to bind metallic impurities on semiconductor wafers prior to the formation of a gate electrode. By using the bidentate chemical complexing agents in a ratio to metal centers of 3 to 1, a six coordinate chelation can be achieved. The resulting chelate may be permanently removed under dynamic vacuum or in a stream of supercritical carbon dioxide, to mention two examples.

The use of bidentate chelation may be a cleaner, more versatile approach compared to using hexadentate chelation by a single, non-volatile, large complexing agent. Of course, the large complexing agent, which is hexadentate, can only be implemented in an aqueous media. The use of the aqueous media limits the variability of the final molecular surface termination.

The bidentate chelation of metal atoms or ions that are undesirably adhered to semiconductor surfaces and films may be achieved by volatile complexing agents. Thus, the resulting hexacoordinate species with three chelators and a metal center may be removed relatively simply because of the volatility of the complexing agents.

Examples of bidentate chelators that are volatile and/or removable in supercritical carbon dioxide include N,N′ chelators, such as ethylene diamine and bipyridine. In this case, two nitrogen atoms each can donate a pair of electrons to the metal center, achieving two coordination points. Similarly, O,O′ chelators, such as acetylacetone and dimethoxyethane, may be used. Again, these are bidentate chelators which have two oxygen atoms that can form two points of the action. As still another example, P,P′ chelators, such as dimethylphosphinoethane, may be used.

The three chelating ligands may bind to each metal center. The result is a hexadentate structure when the combined effect of the three chelating ligands is achieved.

When it is desired to remove a particular metal, a chelator specific to that metal may be chosen. In other words, a chelator may be selected that has a particular affinity for the metal sought to be removed. Alternately, a variety of chelators may be used so that the best combination may be achieved in any given circumstance, in some cases even when the contaminating metal is of unknown chemistry.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
exposing a semiconductor wafer to bidentate chelating ligands; and
removing metal complexes formed by those chelating ligands.

2. The method of claim 1 wherein removing metal complexes includes volatilizing the metal complexes.

3. The method of claim 1 wherein removing the metal complexes includes using supercritical carbon dioxide to remove said complexes.

4. The method of claim 1 including removing said metal complexes as a vapor.

5. The method of claim 1 wherein removing said metal complexes includes removing three bidentate chelating ligands per metal center.

6. A method comprising:
exposing a semiconductor wafer to chelating ligands; and
removing a vapor including the chelating ligands and a metal center.

7. The method of claim 6 wherein removing metal complexes includes volatilizing the metal complexes.

8. The method of claim 6 wherein removing the metal complexes includes using supercritical carbon dioxide to remove said complexes.

9. The method of claim 6 wherein removing said metal complexes includes removing three bidentate chelating ligands per metal center.

10. The method of claim 6 including exposing said wafer to bidentate chelators.

11. The method of claim 10 including exposing the wafer to bidentate O,O′ chelators.

12. The method of claim 10 including exposing said wafer to N,N′ chelators.

13. The method of claim 10 including exposing said wafer to P,P′ chelators.

14. A cleaning composition comprising:
supercritical carbon dioxide; and
bidentate chelating ligands.

15. The composition of claim 14 wherein said ligands are N,N′ chelators.

16. The composition of claim 14 wherein said ligands include O,O′ chelators.

17. The composition of claim 14 wherein said ligands include P,P′ chelators.

18. A method comprising:
volatilizing chelators; and
exposing a semiconductor wafer to said volatilized chelators.

19. The method of claim 18 including volatilizing bidentate chelators.

20. The method of claim 18 including removing metal complexes formed by the chelators.
